(19) United States
(12) Patent Application Publication
(10) Pub. No.: US 2011/0306224 A1
(43) Pub. Date: Dec. 15, 2011

(54) ELECTRICAL CARD CONNECTOR HAVING IMPROVED CARD LOCKING ELEMENT

(75) Inventors: JING-JIE GUO, Shenzhen (CN); WEI-JIE HUO, Shenzhen (CN)

(73) Assignee: HON HAI PRECISION INDUSTRY CO., LTD., New Taipei (TW)

(21) Appl. No.: 13/157,369

(22) Filed: Jun. 10, 2011

(30) Foreign Application Priority Data
Jun. 10, 2010 (CN) 201020221931.1

(51) Int. Cl. H01R 13/62

(52) U.S. Cl. 439/159

(57) ABSTRACT

An electrical card connector (100) includes an insulating housing (1), a number of terminals (2) received in the insulating housing (1), a metal shield (4) shielding over the insulating housing (1) for defining a card receiving space (6), and an ejector (3) movably retained to the insulating housing. The ejector (13) includes a slider (31), a pin member (32) with one end thereof secured in the insulating housing (1) and another end thereof movably received in the slider (31), and a locking element (34) movably connected with the slider (31). The locking element (34) comprises a first curved portion (342) protruding towards the card receiving space (6), a second curved portion (343) protruding away from the card receiving space (6), and a locking portion (341) for locking with an inserted card.

### BACKGROUND OF THE INVENTION

1. Field of the Invention

The present invention relates generally to electrical card connectors, and more particularly to an electrical card connector having locking element for maintaining an inserted card steadily in the card receiving space.

2. Description of Related Arts

Nowadays, electrical card connectors are widely used in computers, mobile phones, cameras, etc. to receive an electrical card. The electrical card presents as a media for storing and transmitting data to and from the computers, mobile phones, cameras or the like.

Taiwan Patent No. M379213 discloses an electrical card connector comprising an insulating housing, a shield shielding over the insulating housing for defining a card receiving space, a plurality of terminals received in the insulating housing, and an ejector retained in the insulating housing. The ejector comprises a slider, a spring, a pin member and a locking member for locking an inserted card. The locking member is of a metallic piece and defines a fixing portion fixed in the slider, a cantilevered beam extending from the fixing portion, and a locking portion extending upward from the cantilevered beam for engaging an recess or notch of the inserted card. U.S. Pat. No. 7,632,117 discloses an electrical card connector comprising an insulating housing having a base, left and right side walls, and a rear wall to commonly define a rectangular receiving space therebetween, an ejecting member disposed adjacent the right side wall and within the receiving space, the ejecting member including a slider defining an integral locking head. However, the elasticity of the locking members said above will be exhausted after plurality of insertion/ejection of the card and therefore, the locking member can not lock with the inserted card for ever.

Hence, an improved card locking element on an electrical card connector is desired.

### SUMMARY OF THE INVENTION

Accordingly, an object of the present invention is to provide an electrical card connector having locking element for maintaining an inserted card steadily in the card receiving space.

To achieve the above object, an electrical card connector includes an insulating housing, a plurality number of terminals received in the insulating housing, a metal shield shielding over the insulating housing for defining a card receiving space, and an ejector movably retained to the insulating housing. The ejector includes a slider, a pin member with one end thereof secured in the insulating housing and another end thereof movably received in the slider, and a locking element movably connected with the slider. The locking element comprises a first curved portion protruding towards the card receiving space, a second curved portion protruding away from the card receiving space, and a locking portion for locking with an inserted card.

Other objects, advantages and novel features of the invention will become more apparent from the following detailed description when taken in conjunction with the accompanying drawings.

### BRIEF DESCRIPTION OF THE DRAWING

FIG. 1 is a perspective, assembled view of an electrical card connector according to the present invention;

FIG. 2 is a perspective, partly assembled view of an electrical card connector according to the present invention; and

FIG. 3 is a perspective, exploded view of the electrical card connector.

### DETAILED DESCRIPTION OF THE PREFERRED EMBODIMENT

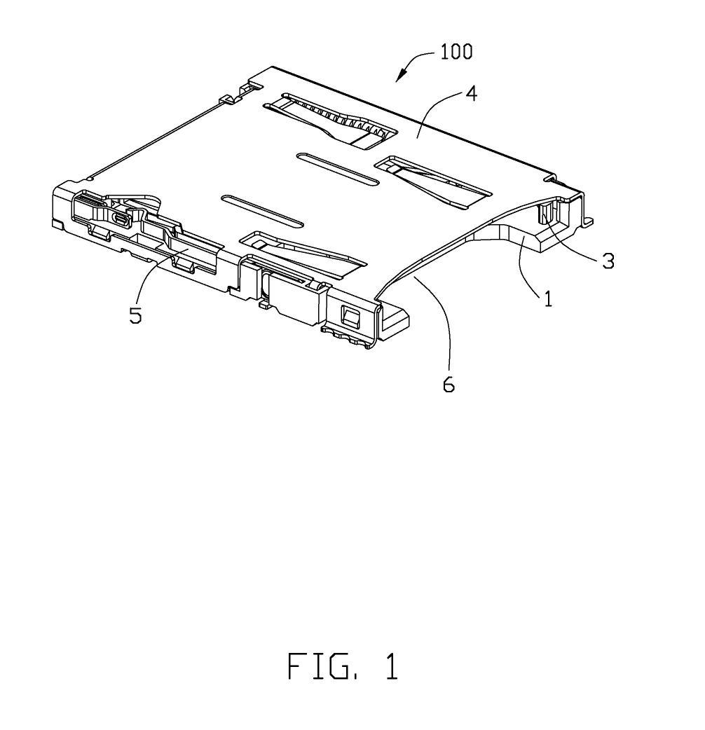

FIGS. 1-3 illustrate an electrical card connector 100 in accordance with the present invention. The electrical card connector 100 includes an insulating housing 1, a plurality of terminals 2, an ejector 3, a switch element 5, and a metal shield 4 assembled on and shielding the insulating housing 1 for defining a card receiving space 6. The terminals 2, the ejector 3 and the switch element 5 are all received in the insulating housing 1.

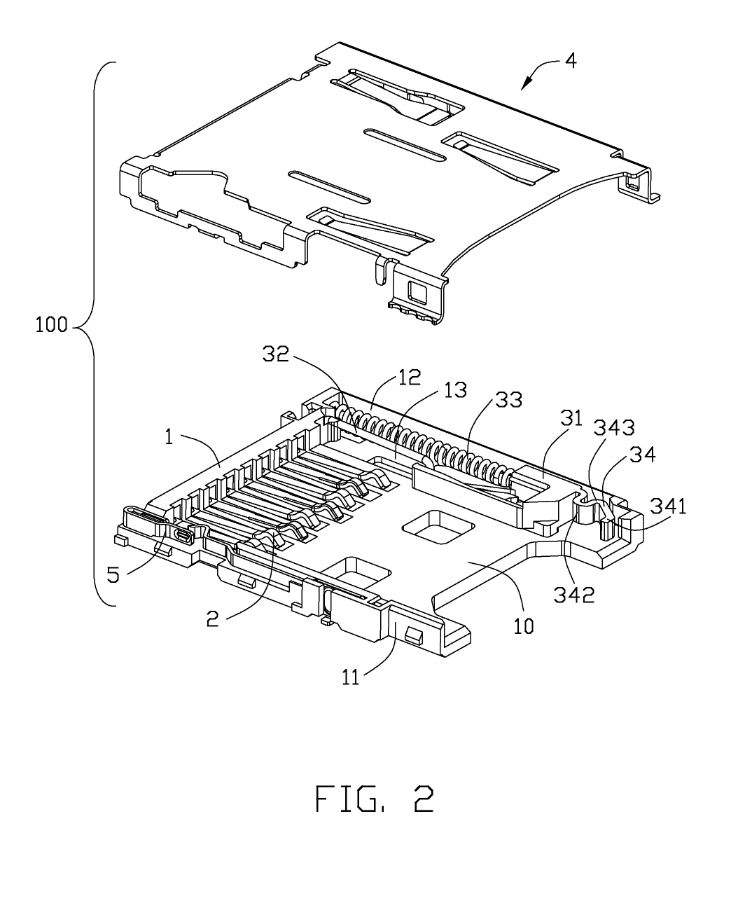

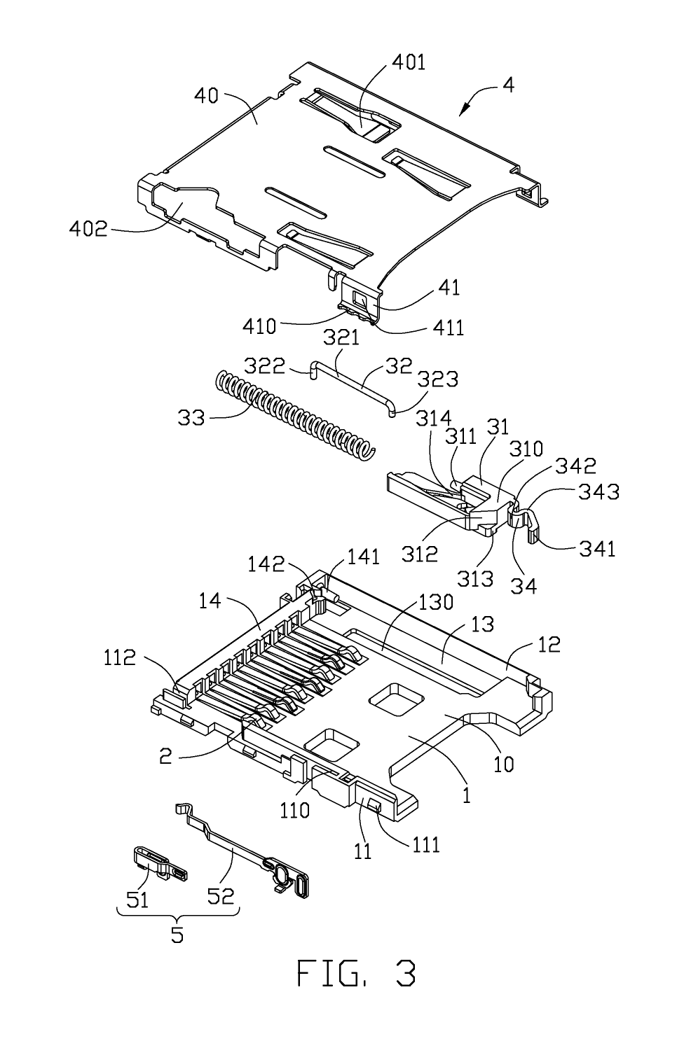

Referring to FIGS. 2-3, the insulating housing 1 comprises a base portion 10, a first arm portion 11 and a second arm portion 12 extending upwardly from the two sides of the base portion 10, and a transversal wall 14 extending upwardly from the back of the base portion 10. Each of the first arm portion 11 and the second arm portion forms a plurality of protrusions 111 extending outwardly from two sides thereof to engage with the metal shield 4. The base portion 10 further defines a plurality of terminal receiving passageways (not labeled) for receiving the terminals 2. The insulating housing 1 defines a first fastening slot 112 extending through the transversal wall 14 along a longitudinal direction which is located at the rear end of the first arm portion 11. The first arm portion 11 defines a second fastening slot 110 extending downwardly from a top side thereof and located adjacent to the front end thereof. The second arm portion 12 defines a cavity 13 to receive the ejector 3, and a guiding slot 130 below the cavity 13. The cavity 13 and the guiding slot 130 extend along the longitudinal direction. The second arm potion 12 defines a positioning hole 142 at a rear end thereof, and a first post 141 located beside the positioning hole 142 and extending forwardly.

Referring to FIG. 3, the metal shield 4 comprises a flat portion 40 and a pair of sidewalls 41 extending downward from two edges of the flat portion 40. The flat portion 40 defines a spring arm 401 extending downwardly. The depending portion 41 defines a plurality of locking holes 411 to lock with the protrusions 111, and a plurality of soldering tail 410 extending outwardly from a front and lower end thereof to be soldered on a circuit board (not shown). The metal shield 4 also defines an opening 402 at the joint of the flat portion 40 and one of the sidewalls 41.

The switch element 5 comprises a first contact 51 received in the first fastening slot 112 and a second contact 52 received in the second fastening slot 110. The switch element 5 is exposed in the air through the opening 402 of the metal shield 4.

The ejector 3 is retained in the cavity 13, and comprises a slider 31, a spring 33, a pin member 32 and a locking element 34.

The slider 31 defines a base 310, a heart-shaped recess 314 recessed downwardly from a top surface thereof, a second post 311 extending backwardly from the rear end of the base 310 towards the first post 141, and a guiding portion 313 protruding downward from a bottom surface thereof The guiding portion 313 moves in the guiding slot 130 to guide the slider 31 moving along a card's insertion or ejection direction. The base 310 defines an inclined surface 312 in the front end thereof, the inclined surface 312 could abut against an inserted card along an oblique direction.

The locking element 34 defines a first curved portion 342 extending forwardly from the slider 31 and protruding towards the card receiving space 6, a second curved portion 343 extending from the first curved portion 342 and protruding away from the card receiving space 6, and a locking portion 341 extending from a free end of the second curved portion 343 towards the card receiving space 6. The first curved portion 342 extends from the front end of the slider 31, and is molded with the slider 31. The first curved portion 342, the second curved portion 343 and the locking portion 341 are in the same horizontal plane.

The spring 33 extends along the card's insertion/ejection direction and has a front end fixed on the second post 311 and a rear end fixed on the first post 141. The pin member 32 has a main portion 321 extending along the card's insertion/ejection direction, a first fixing portion 322 bending downwardly from a rear end of the main portion 321 to be fixed in the positioning hole 142, and a second fixing portion 323 received in the heart-shaped recess 314. When an electrical card is inserted in or ejected from the receiving space 6, the second fixing portion 323 moves in the heart-shaped recess 314. The top side of the main portion 321 is resisted by the spring arm 401 of the shield 4 to make sure the second fixing portion 323 always in the heart-shaped recess 314.

Because of the first curved portion 342, the second curved portion 343, and the locking portion 341, the locking element 34 has an excellent elasticity, and so, when an electrical card is inserted in or ejected from the receiving space 6, the locking portion 341 could lock with the inserted card steadily and prevent the inserted card away from the card receiving space 6.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical card connector comprising:
an insulating housing;
a plurality of terminals received in the insulating housing;
a metal shield shielding over the insulating housing for defining a card receiving space; and
an ejector movably retained to the insulating housing and including a slider, a pin member with one end thereof secured in the insulating housing and another end thereof movably received in the slider, and a locking element movably connected with the slider, the locking element comprising a first curved portion protruding towards the card receiving space, a second curved portion protruding away from the card receiving space, and a locking portion for locking with an inserted card.

2. The electrical card connector as described in claim 1, wherein the locking element is molded with the slider.

3. The electrical card connector as described in claim 2, wherein the first curved portion extends forward from the slider, the second curved portion extends from the first curved portion, and the locking portion extends from a free end of the second curved portion.

4. The electrical card connector as described in claim 3, wherein the first curved portion, the second curved portion and the locking portion are in the same horizontal plane.

5. The electrical card connector as described in claim 1, wherein the slider defines a guiding portion protruding downwardly from a bottom surface thereof, the insulating housing defines a guiding slot extending along a card insertion/ejection direction, the guiding portion moves in the guiding slot to guide the slider moving along the card insertion/ejection direction.

6. The electrical card connector as described in claim 5, wherein the slider defines an inclined surface in the front end thereof to guide an electrical card.

7. The electrical card connector as described in claim 1, wherein the metal shield comprises a flat portion and a pair of sidewalls, and the flat portion defines a spring arm extending downwardly to resist a top side of the pin member.

8. An electrical card connector comprising:
an insulating housing defining a cavity recessed from one side thereof;
a plurality of terminals received in the insulating housing;
a metal shield shielding over the insulating housing for defining a card receiving space; and
an ejector movably retained in the cavity, including a slider, a pin member with one end thereof secured in the insulating housing and another end hereof movably received in the slider, a spring, and a locking element connected with the slider,
wherein the locking element comprises a first curved portion protruding towards the card receiving space, a second curved portion protruding away from the card receiving space, and a locking portion towards the card receiving space.

9. The electrical card connector as described in claim 8, wherein the first curved portion extends forward from the slider, the second curved portion extends from the first curved portion, and the locking portion extends from a free end of the second curved portion.

10. An electrical card connector for use with an electronic card, comprising:
an insulative housing defining a card receiving cavity;
a plurality of contacts disposed in the housing with contacting sections extending into the card receiving cavity;
a metallic shell assembled to the housing to cooperate with the housing for enclosing the electronic card;
a slider back and forth moveable with regard to the housing along a front-to-back direction via a pin member moving along a heart-shaped groove with assistance of a spring; and
a locking element associated with the ejection mechanism; wherein
said locking element defines an S-like configuration with a locking portion at a free end of said S-like configuration.

11. The electrical card connector as claimed in claim 10, wherein said locking element is located at a front end of the locking element.

12. The electrical card connector as claimed in claim 10, wherein the heart-shaped groove is defined in the slider.

13. The electrical card connector as claimed in claim 12, wherein the pin element is pivotally fixed to the housing.

14. The electrical card connector as claimed in claim 10, wherein the housing defines a shoulder structure to comply with a contour of the locking element.
